(19) United States
(12) Patent Application Publication
(10) Pub. No.: US 2017/0319957 A1
(43) Pub. Date: Nov. 9, 2017

(54) METHOD AND DEVICE FOR INTERACTION OF A CLIENT TERMINAL WITH AN APPLICATION EXECUTED BY A PIECE OF EQUIPMENT, AND TERMINAL USING SAME

(71) Applicant: ORANGE, Paris (FR)

(72) Inventors: Maximilien Baumann, Montigny Le Bretonneux (FR); Sandrine Lacharme, Lannion (FR)

(21) Appl. No.: 15/529,457

(22) PCT Filed: Nov. 24, 2015
(86) PCT No.: PCT/FR2015/053199

§ 371 Date: May 24, 2017

(30) Foreign Application Priority Data
Nov. 27, 2014 (FR) 1461604

(51) Int. Cl. A63F 13/355; A63F 13/52; G06F 9/44; H04L 29/08

(52) U.S. Cl. CPC A63F 13/355; H04L 67/303; A63F 13/52; G06F 9/4445

(57) ABSTRACT

The invention concerns a method of interaction with an application executed by a piece of equipment separate from a client terminal implementing the method of interaction. In particular, the method of interaction is a method for interaction of a client terminal with an application executed remotely. The application executed remotely is, in particular, a video game broadcast using, for example, a WebRTC communication protocol. One piece of subject matter of the invention is a method of interaction with an application, executed by a piece of equipment, providing a video stream displayed by a client terminal separate from the piece of equipment, the method of interaction comprising a transmission of a piece of position information suitable as an interaction position input parameter of the application, the suitable position information being dependent: —on a client position of a positional interface relative to an image of the video stream, —and proportional to the ratio between a resolution of the piece of equipment and a suitable client resolution. Therefore, interaction errors during the remote execution of an application are avoided, while limiting the network load and calculation costs, and maintaining the real-time character.

The invention relates to a method of interaction with an application executed by a piece of equipment distinct from a client terminal implementing the method of interaction. In particular, the method of interaction is a method for interaction of a client terminal with an application executed remotely. The application executed remotely is notably a video game broadcast using, for example, a WebRTC communications protocol.

Historically, video games were recorded on media (DVD, cartridges, etc.) sold to users who inserted it into their local games terminal (computers, consoles, etc.) and interacted locally by means of joysticks, or of the keyboard and/or of the mouse of the computer, etc.

With the advent of software means to replace hardware, users no longer acquired their games by purchasing media but by downloading them from a remote sales/subscription site. However, the games were still executed locally.

Progressively, with the advent of online games, certain elements of the games have been transferred into the communications network, up to and including the execution of the game itself. The problem was then posed of the local interaction with a game executed remotely, notably since the position of the mouse, of the characters in the game, etc. on the local screen did not correspond to that of the game in the network. This is notably due to differences in resolution between the local screen and the game executed in the network, to the position and/or to the size of the display window on the local screen, etc.

Until now, this problem has been solved by transmitting to the equipment executing the game the image including the interaction, in other words the image displayed on the local screen comprising not only the image of the game but also the image of the mouse.

One of the aims of the present invention is to provide improvements with respect to the prior art.

One subject of the invention is a method for interaction with an application, executed by a piece of equipment, supplying a video stream displayed by a client terminal, distinct from the equipment, the method of interaction comprising the transmission of appropriate position information as an interaction position input parameter for the application, the appropriate position information being dependent:
on a client position of a positional interface with respect to an image of the video stream,
and proportional to the ratio between a resolution of the equipment and an appropriate client resolution.

Thus, the interaction errors during the remote execution of an application are avoided while at the same time limiting the network load and the processing costs, and while conserving the real-time nature.

Advantageously, the method comprises an adaptation of the client position of the positional interface in proportion to the ratio between the resolution of the equipment and the appropriate client resolution.

Advantageously, the method of interaction comprises an acquisition of the appropriate client resolution, the appropriate client resolution being used by the client terminal as display video marker.

Thus, the processing cost is shared between the display and the interaction, allowing an overall reduction in the client processing cost.

Advantageously, the appropriate client resolution is a function of an equipment resolution, the equipment resolution being a resolution of a piece of equipment executing the application and supplying a resulting video stream, of a size of a display window of the video stream and of a precision parameter, the appropriate client resolution having the same relationship as the equipment resolution to the size of the display window in which the video stream is displayed by a terminal.

Thus, the adaptation of the interaction takes into account the necessity for adaptation of the local display. In particular, the fact that the display of a real-time video stream can be re-dimensioned while at the same time conserving the real-time nature, without deformation and with no loss of quality during the displaying of the video carried by the video stream. The precision parameter notably allows the ratio of the original video 4:3, 16:9, etc., to be conserved.

Advantageously, each dimension of the appropriate position is equal to a corresponding dimension of the client position multiplied by the corresponding dimension of the equipment resolution multiplied by 1, from which the equipment resolution divided by the appropriate client resolution has been subtracted.

Advantageously, the appropriate position information is a function of the position of a client display window relative to a screen of a client terminal displaying the client display window.

Thus, the adaptation of the position takes into account the fact that the position of the interaction is shifted when the application is not displayed over the entirety of the local screen.

Advantageously, each dimension of the appropriate position is shifted positively as a function of a corresponding dimension of the position of the client display window multiplied a corresponding dimension of the client position multiplied by the corresponding dimension of the equipment resolution divided by the appropriate client resolution.

Advantageously, the image supplied by the execution of the application is supplied in a video stream broadcast in a real-time Web communication session.

Advantageously, the method of interaction is implemented locally, when the application is executed remotely.

Advantageously, according to one embodiment of the invention, the various steps of the method according to the invention are implemented by a software application or computer program, this software application comprising software instructions intended to be executed by a data processor of a device forming part of a terminal and being designed for controlling the execution of the various steps of this method.

The invention is therefore also aimed at a program comprising program code instructions for the execution of the steps of the method of interaction as claimed in any one of the preceding claims when said program is executed by a processor.

This program may use any given programming language and be in the form of source code, object code or code intermediate between source code and object code, such as in a partially compiled form, or in any other desired form.

Another subject of the invention is a device for interaction of a client terminal with a piece of equipment executing an application and supplying a video stream displayed by the client terminal distinct from the equipment, the interaction device comprising a transmitter, to the equipment, of appropriate position information as interaction position input parameter for the application, the appropriate position information being dependent:
on a client position of a positional interface with respect to an image of the video stream,
and proportional to the ratio between a resolution of the equipment and an appropriate client resolution.

A further subject of the invention is a client terminal comprising:
a screen designed to display, in a display window, a video stream supplied by a piece of equipment executing an application, and supplying a video stream displayed by the client terminal, distinct from the equipment,
a user interface allowing a positional interface to be moved over the screen relative to an image of the video stream,
a device for interaction of the client terminal with the equipment, comprising a transmitter, to the equipment, of appropriate position information as interaction position input parameter for the application, the appropriate position information being dependent:
   on a client position of a positional interface with respect to an image of the video stream,
   and proportional to the ratio between a resolution of the equipment and an appropriate client resolution.

The features and advantages of the invention will become more clearly apparent upon reading the description, presented by way of example, and from the figures referring to it, which show:

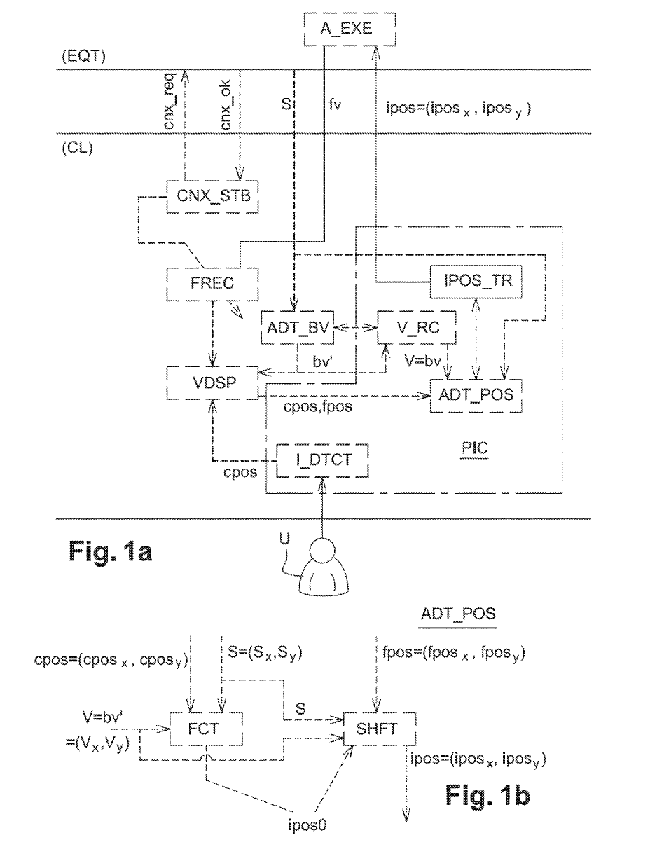

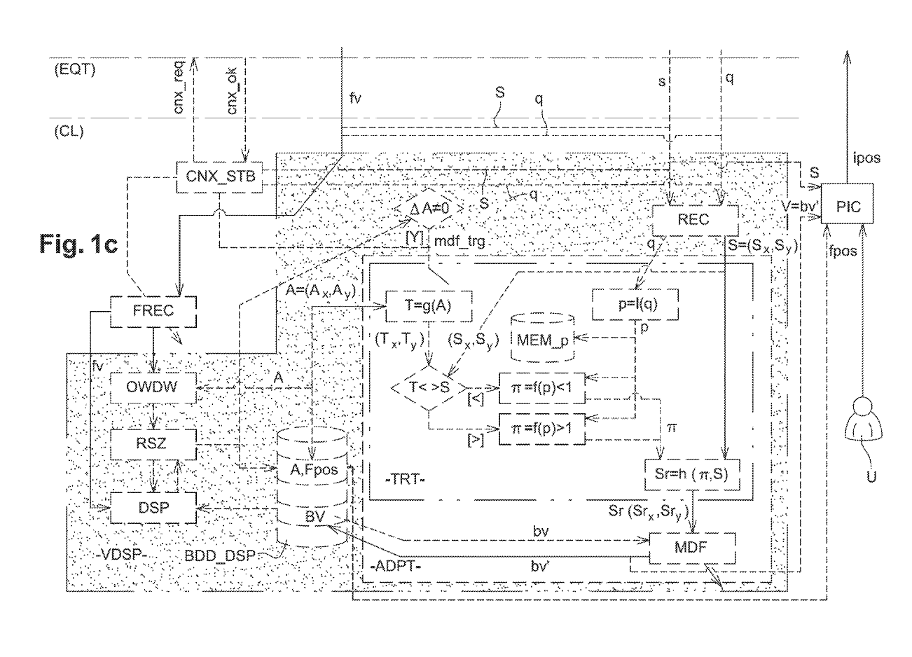

FIGS. 1a, 1b, and 1c, simplified diagrams of the method of interaction according to the invention, respectively in the general framework of the execution of an application, of a position adaptation of the method of interaction, in combination with a display adaptation method,

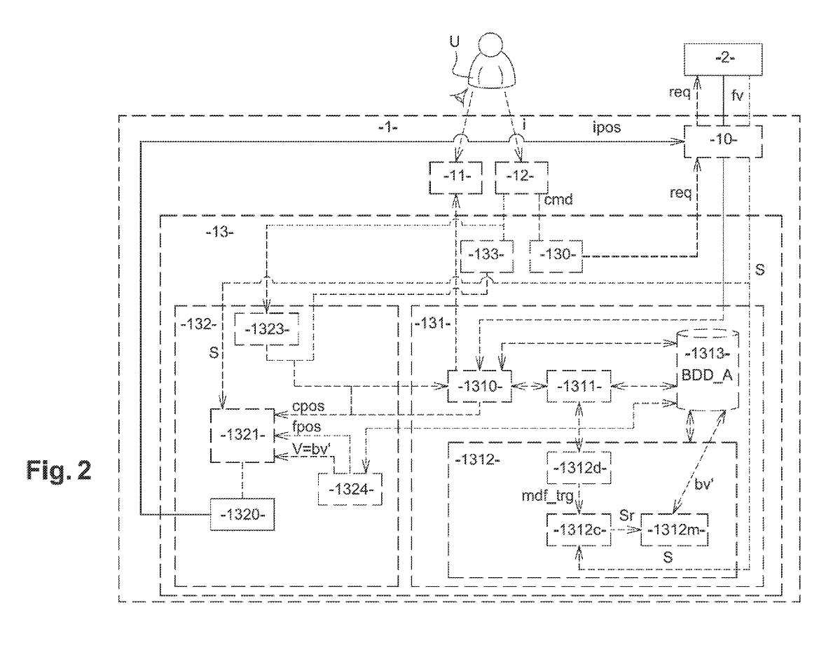

FIG. 2, a simplified diagram of a client terminal comprising an interaction device according to the invention.

FIGS. 1a, 1b, and 1c show simplified diagrams of the method of interaction according to the invention. FIG. 1a illustrates, in particular, the method of interaction in the general framework of the execution of an application.

The method of interaction PIC with an application, executed by a piece of equipment EQT, supplying a video stream fv displayed by a client terminal CL, distinct from the equipment, comprises the transmission IPOS_TR of appropriate position information ipos as interaction position input parameter for the application. The appropriate position information ipos is dependent:
on a client position cpos of a positional interface with respect to an image of the video stream fv,
and proportional to the ratio between a resolution of the equipment S and an appropriate client resolution V.

Thus, the interaction errors, during the remote execution of an application, are avoided while at the same time limiting the network load and the processing costs, and while conserving the real-time nature (in particular, when the application is executed by a piece of equipment remote from the client terminal).

In particular, the method of interaction PIC comprises an adaptation ADT_POS of the client position cpos of the positional interface in proportion to the ratio between the resolution of the equipment S and the appropriate client resolution V.

In particular, the method of interaction PIC comprises an acquisition V_RC of the appropriate client resolution V, the appropriate client resolution V being used by the client terminal CL as display video marker bv′.

Notably, the client terminal CL adapts its display by determining this video marker bv′. In particular, a display adaptation process ADT_BV for a video stream fv by a client CL supplies an appropriate client resolution V as video marker bv′. The appropriate client resolution V is notably a function of a resolution S of a piece of equipment EQT supplying the video stream fv, of a size T of a display window of the video stream and of a precision parameter p.

Thus, the processing cost is shared between the display and the interaction, allowing an overall reduction of the client processing cost.

Either, the video adaptation process ADT_BV is integrated into a display process VDSP: the process VDSP for displaying a video stream fv by a client CL then comprises the adaptation ADT_BV of a display of the video stream (not shown).

Or, the video adaptation process ADT_BV exchanges with the display process VSDP (example illustrated by FIG. 1a), the display process VDSP supplying the size T of the display window and the video adaptation process ADT_BV the modified video marker bv′, either directly or indirectly, for example by storing in a display database comprising the size A of the client window on which the size T of the display window, the video marker BV, the position of the display window fpos, etc. are dependent.

In particular, the image supplied by the execution of the application A_EXE is supplied in a video stream fv broadcast in a real-time Web communication session.

In particular, the method of interaction PIC is implemented locally, when the application is executed A_EXE remotely.

In particular, a client video streaming service process comprises an establishment CNX_STB of a connection of the client terminal CL with a piece of equipment EQT supplying video streams, or even supplying the video streaming service. For example, the establishment of a connection CNX_STB implemented by the client terminal CL sends a connection request cnx_req to the equipment EQT initiating the connection.

Notably, the connection is not initiated for as long as the establishment CNX_STB of a connection has not received a connection agreement cnx_ok or a connection request receipt acknowledgement (not shown) coming from the equipment EQT.

The connection or, more particularly, the establishment of the connection CNX_STB initiates the method of interaction PIC according to the invention and, where necessary, the implementation of the video adaptation process ADT_BV.

Thus, any movement of the positional interface the transmission IPOS_TR by the method of interaction PIC of appropriate position information ipos, instead of the position information cpos of the position interface, to the equipment EQT.

Once the connection has been established CNX_STB, the client process comprises a reception of a video stream FREC which triggers the display process VDSP for displaying the received video stream fv.

One particular embodiment of the method of interaction PIC is a program comprising program code instructions for the execution of the steps of the method of interaction as claimed in any one of the preceding claims when said program is executed by a processor.

FIG. 1b illustrates, in particular, a position adaptation of the method of interaction according to the invention.

In particular, the adaptation of the position ADT_POS comprises a proportional operation FCT supplying appropriate position information ipos dependent on the position of the positional interface cpos and proportional to the ratio between an equipment resolution S and an appropriate client resolution V.

Notably, the proportional operation FCT performs the following operation: ipos=cpos (V−S) S/V.

In particular, each dimension of the appropriate position iposx, iposy (in the two-dimensional case) is equal to a corresponding dimension of the client position cposx, cposy multiplied by the corresponding dimension of the equipment resolution Sx. Sy multiplied by 1 from which the equipment resolution Sx, Sy divided by the appropriate client resolution Vx, Vy has been subtracted.

iposx=cposx Sx(1−Sx/Vx)

iposy=cposy Sy(1−Sy/Vy)

In particular, the adaptation of the position ADT_POS comprises a shift operation SHFT supplying appropriate position information ipos re-adjusted as a function of the position of the display window fpos.

In particular, the appropriate position information ipos is a function of the position of a client display window fpos relative to a screen of a client terminal displaying the client display window.

Thus, the adaptation of the position takes into account the fact that the position of the interaction is shifted when the application is not displayed over the entirety of the local screen.

Notably, the shift operation SHFT performs the following operation: ipos=ipos0+cpos*fpos*S/V, where ipos0 is the appropriate position information before the shift, in other words for a display window positioned at the point of origin of the screen.

In particular, each dimension of the appropriate position iposx, iposy is shifted positively as a function of a corresponding dimension of the position of the client display window fposx, fposy multiplied by a corresponding dimension of the client position cposx, cposy multiplied by the corresponding dimension of the equipment resolution Sx, Sy divided by the appropriate client resolution Vx, Vy.

iposx=iposx0+cposx*fposx*Sx/Vx

iposy=iposy0+cposy*fposy*Sy/Vy

which gives:

$$\begin{matrix}Iposx = cposx * Sx ( 1 - Sx / Vx ) + cposx * fposx * Sx / Vx \\ = cposx * ( ( Vx - Sx ) + fposx ) * Sx / Vx\end{matrix}$$

$$\begin{matrix}Iposy = cposy * Sy ( 1 - Sy / Vy ) + cposy * fposy * Sy / Vy \\ = cposy * ( ( Vy - Sy ) + fposy ) * Sy / Vy\end{matrix}$$

This may be generalized to a number of dimension higher than 2, in particular to 3 dimensions. In the three-dimensional case, the display window will no longer be plane but three-dimensional, and the reproduction device will no longer necessarily be a screen but will nevertheless have a point of origin in a three-dimensional display space.

FIG. 1c illustrates, in particular, a method of interaction according to the invention combined with a display adaptation process,

As in FIG. 1a, FIG. 1c shows a client process implemented by a client terminal CL triggering the execution of an application by a piece of equipment.

In particular, the client video streaming service process comprises an establishment CNX_STB of a connection of the client CL with a piece of equipment EQT supplying video streams, or even supplying the video streaming service. For example, the establishment of a connection CNX_STB implemented by the client CL sends a connection request cnx_req to the equipment EQT initiating the connection.

Notably, the connection is not initiated for as long as the establishment CNX_STB of a connection has not received a connection agreement cnx_ok or a connection request receipt acknowledgement (not shown) coming from the equipment EQT.

The connection or, more particularly, the establishment of the connection CNX_STB triggers mdf_trg in parallel the implementation of a video adaptation process ADT_BV and/or of the modification MDF of the video marker. In the case where it is the modification MDF which is triggered, the modification MDF comprises the processing operation TRT (not shown) or triggers this processing operation TRT.

The resolution S and/or the quality q of the equipment EQT is received REC either by the client process, or within the adaptation process ADPT. In particular, the establishment of the connection CNX_STB acquires the resolution S and/or the quality q from the equipment EQT and supplies them to the adaptation process ADPT.

Once the connection CNX_STB has been established, the client process comprises the reception of a video stream FREC which triggers the display process VDSP in order to display the received video stream fv.

In particular, the appropriate client resolution V=bv′ is a function of an equipment resolution S, the equipment resolution S being a resolution of a piece of equipment EQT executing the application and supplying the resulting video stream fv, of a size of a display window T of the video stream and of a precision parameter q, the appropriate client resolution V having the same relationship as the equipment resolution S to the size of the display window T in which the video stream is displayed by a client terminal.

Thus, the adaptation of the interaction takes into account the necessity to adapt the local display. In particular, the fact that the display of a real-time video stream may be re-dimensioned while at the same time conserving the real-time nature, without deformation and with no loss of quality during the display of the video carried by the video stream. The precision parameter notably allows the ratio of the original video 4:3, 16:9, etc., to be conserved

The video adaptation process ADT_BV for display of a video stream fv by a client CL comprises, for example, a modification MDF of a video marker BV of the client CL. The modified video marker V=bv′ is thus dependent on a resolution S of a piece of equipment EQT supplying the video stream fv, of a size T of a display window of the video stream and of a precision parameter p. The modified video marker bv′ has the same relationship as the resolution S to the size T of the display window in which the video stream is displayed by the client.

In the case of a two-dimensional display, the resolution of the equipment is two-dimensional S=(Sx,Sy), as is the size of the display window T=(Tx,Ty).

In particular, the adaptation process comprises, following receipt REC of at least the resolution S of the equipment EQT supplying the video stream fv, a processing TRT of said resolution S as a function of the precision parameter p, the resolution resulting from the processing operation Sr being used in the video marker modification step MDF.

In particular, the modified video marker bv′ is proportional to the resolution S: bv′=(π Sx, π Sy), where π is a proportionality factor being a function of the precision parameter p: π=f(p).

Notably, the resulting resolution Sr used to modify MDF the video marker is proportional to the resolution S: Sr′=h(π, S), where π is a proportionality factor for the precision parameter p: π=f(p) allowing the ratio of the resolution of the equipment to be conserved.

In particular, the modification MDF is implemented when at least one of the dimensions of the size of the display window of the client is smaller than one of the dimensions of the resolution (T< >S=[<]). For example, if Tx<Sx or Ty<Sy, then the modification MDF is implemented.

Notably, the adaptation process comprises a verification of the relationship of the resolution with respect to the size T< >S. When the relation is [<]: the size T is less than the resolution S, in particular in at least one of their dimensions, the verification T< >S triggers the modification MDF of the video marker.

In this case of a relationship of lower inequality [<], the proportionality factor t is, for example, less than 1.

In particular, in this case of a relationship of lower inequality [<], each dimension of the modified video marker (bv′x,bv′y) is equal to the corresponding dimension of the resolution (Sx, Sy) multiplied by the precision parameter, from which 1 has been subtracted (p−1), and divided by the precision parameter p:

if Tx<Sx or Ty<Sy,

then bv′x=(p−1)Sx/p and bv′y=(p−1)Sy/p

giving bv′x=π Sx and bv′y=π Sy with π=f₋(p)=(p−1)/p

In particular, the modification MDF is implemented when at least one of the dimensions of the size of the display window of the client is greater than one of the dimensions of the resolution (T< >S=[>]. For example, if Tx>Sx or Ty>Sy, then the modification MDF is implemented.

Notably, the adaptation process comprises a verification of the relationship of the resolution with respect to the size T< >S. When the relationship is [>]: the size T is larger than the resolution S, in particular in at least one of their dimensions, the verification T< >S triggers the modification MDF of the video marker.

In this case, of a relationship of greater inequality [>], the proportionality factor r is, for example, greater than 1.

In particular, in this case of a relationship of greater inequality [>], each dimension of the modified video marker (bv′x,bv′y) is equal to the corresponding dimension of the resolution (Sx, Sy) multiplied by the precision parameter from which 1 has been subtracted (p+1), and divided by the precision parameter p:

if Tx>Sx or Ty>Sy,

then bv′x=(p+1)Sx/p and bv′y=(p+1)Sy/p

giving bv′x=π Sx and bv′y=π Sy with π=f₊(p)=(p+1)/p

In particular, the precision parameter is a predefined parameter, for example within a range from 95 to 1000. Notably, the precision parameter may be fixed at 100 irrespective of the equipment EQT supplying a video stream with a VGA quality of the order of 720 pixels, but also of the order of 1080p, or again for less common qualities, such as 4:3.

The optimization of the display both in terms of size, of deformation and of quality of display seems to be obtained for a precision parameter p fixed at a value of around 100. In order to enhance the quality of the display, the precision parameter p will be fixed at a higher value, notably at 1000.

Notably, the predefined precision parameter p is read from a memory MEM_p.

In particular, the precision parameter p is a function of the quality q of the video stream fv: p=l(q). Thus, the modification MDF is also a function of the quality q of the video stream fv. Thus, the modification will not be the same depending on the quality of the equipment EQT supplying the video stream f: for example, for a first piece of equipment EQT1 with a VGA quality 720p, the precision parameter p will take a value of 100 and for a second piece of equipment EQT2 with a quality of 4K, the precision parameter p will automatically adopt another value, for example 4000.

One embodiment of the video adaptation process ADT_BV is a program comprising program code instructions for the execution of the steps of the adaptation process when said program is executed by a processor.

Either, the video adaptation process ADT_BV is integrated into a display process VDSP: the display process VDSP for a video stream fv by a client CL then comprises the adaptation ADAPT of a display of the video stream. The adaptation ADAPT implements a modification MDF of a video marker by of the client CL. The modified video marker bv′ is a function of a resolution S of a piece of equipment EQT supplying the video stream N, of a size T of a display window for the video stream and of a precision parameter p. The modified video marker bv′ has the same relationship as the resolution S to the size S of the display window in which the video stream is displayed by the client.

Or, the adaptation process Video ADT_BV exchanges with the display process VSDP (example not shown), the display process supplying the size T of the display window and the adaptation process the modified video marker bv′, either directly or indirectly, for example by storing in a display database BDD_A comprising the size A of the client window on which the size T of the display window, the video marker BV, etc. are dependent.

In particular, the display process comprises an opening of the display window OWDW in which the video stream fv received by the client CL will be displayed. Notably, the opening of the window reads the size of the client window A, i.e. A=(Ax,Ay) for a two-dimensional display, in a display database BDD_A.

In particular, the display process comprises a display DSP of the video carried by the video stream fv received by the client CL as a function of the video marker, notably the video marker BV read in a display database BDD_A or directly supplied bv′ by the adaptation process ADPT.

In particular, the display process comprises a modification of the size of the display window RSZ prior to or during the display process DSP. The new size A of the client window and/or the new size M of the menu of the client and/or the new size W of the menu of the service implemented by the equipment EQT supplying the video stream Nv are either directly supplied to the video adaptation process ADT_BV, or written into a display database BDD_A.

In particular, a detection of a change of size ΔA≠0 ? triggers mdf_trg either, generally speaking, the adaptation ADPT or, more particularly, the modification MDF. In the case where it is the modification MDF that is triggered, the modification MDF comprises the processing operation TRT (not shown) or triggers this processing TRT.

For example, the detection of a change of size ΔA≠0 ? is integrated either into the video adaptation ADT_BV (not shown) or into the display process VSDP. Notably, the detection of a change of size ΔA≠0 ? comprises a monitoring of the display window and/or of the modification of size RSZ and/or of the size A stored in the display database BDD_A.

In particular, the size of the display window T used for the video adaptation ADT_BV is a function of the size of the client window A: T=g(A). Notably, when certain menus are useful during a video display, it may be envisioned for the display not to take place over the entirety of the client window but only a part of the client window leaving room for the display of one or more menus such as the menu of the client and/or the menu of the video streaming service. The size T of the display window then corresponds to the size of the client window A reduced by the size of the client menu M and/or by the size of the menu of the service W, giving in the case of two-dimensional displays: Tx=Ax−Mx−Wx and Ty=Ay−My−Wy.

One embodiment of the display process VDSP is a program comprising program code instructions for the execution of the steps of the display process when said program is executed by a processor.

In particular, the method of interaction PIC receives or acquires the appropriate client resolution V used as video marker bv′ for the display of the video stream coming from the execution of the application.

Thus, when a user U modifies the position of the positional interface cpos, notably by means of a user interface such as a joystick, a mouse, a tracer pen, etc., the method of interaction PIC transmits appropriate position information ipos to the equipment EQT in order to interact with the application. Either the method of interaction PIC comprises the adaptation of the position ADT_POS (as illustrated in FIG. 1a), or the method of interaction PIC controls a processor designed to perform the position adaptation ADT_POS and to supply it with the resulting appropriate position information ipso.

The method of interaction PIC and/or the position adaptation ADT_POS acquires or receives the elements needed for this position adaptation, such as the appropriate client resolution V received from the video adaptation ADT_BV or acquired in the video marker of the display device of the client terminal or in a display database BDD_DSP, the equipment resolution S coming from the receipt REC, the position of the display window fpos acquired in the parameters of the display device of the client terminal or in a display database BDD_DSP, etc.

FIG. 2 illustrates a simplified diagram of a client terminal 1 comprising an interaction device 132 according to the invention.

The device 132 for interaction of a client terminal 1 with a piece of equipment 2 executing an application and supplying a video stream fv displayed by the client terminal 1, distinct from the equipment 2, comprises a transmitter 1320, to the equipment 2, of appropriate position information ipos as interaction position input parameter for the application, the appropriate position information being dependent:
on a client position cpos of a positional interface with respect to an image of the video stream fv,
and proportional to the ratio between a resolution of the equipment S and an appropriate client resolution V=bv′.

In particular, the interaction device 132 comprises a position adaptor 1321 supplying the appropriate position information ipos to the transmitter 1320. The position adaptor 1321 performs the calculation of the appropriate position information ipos as a function:
of the client position cpos of the positional interface with respect to an image of the video stream fv,
and in proportion to the ratio between the resolution of the equipment S and the appropriate client resolution V=bv′.

In particular, the interaction device 132 comprises a user interface 1323, directly or indirectly manipulated by the user U, such as a joystick, a mouse, a camera for detecting a position of the user, a tracer pen, etc. supplying the client position cpos.

In particular, the interaction device 132 comprises a receiver 1324 receiving or reading in a database or from the parameters of the display window the appropriate client resolution V=bv′, and potentially the position of the display window fpos.

In particular, a client device 13 comprises the interaction device 132, together with a display device 131. Either the client device 13, or the interaction device 132, comprises the respective user interface 133, 1323 allowing the user U to interact with the application and supplying the client position cpos.

The device 131 for displaying a video stream fv in a window of a client device 13 comprises an adaptor 1312 for the display of the video stream. The adaptor 1312 modifies a video marker of the client. The modified video marker is a function of a resolution of a piece of equipment 2 supplying the video stream (such as a video streaming server), of a size of a display window of the video stream and of a precision parameter. The modified video marker has the same relationship as the resolution to the size of the display window in which the video stream is displayed by the client.

In particular, the adaptor 1312 comprises a modification module 1312m for the video marker as a function of a resolution of a piece of equipment 2 supplying the video stream (such as a video streaming server), of a size of a display window of the video stream and of a precision parameter. The modification module 1312m supplies the modified video marker bv′ to the display device 131, directly (not shown) or indirectly, notably by writing it into a display database 1313.

In particular, the adaptor 1312 comprises a processing module 1312c integrated (not shown) or not into the modification module 1312m. The processing module 1312c receives or acquires the resolution S of the equipment 2, directly or indirectly, from the equipment 2 notably by means of the transmitter/receiver 10 of a terminal 1 comprising the client device 13. The processing module 1312c calculates a resulting resolution Sr as a function of the resolution S of the equipment 2, of a precision parameter p and of the size of the display window T. The processing module 1312c supplies the resulting resolution Sr to the modification module 1312m.

In particular, the adaptor 1312 comprises a monitoring module 1312d monitoring the display window, in particular the size of the display window. The monitoring module 1312d triggers, directly or otherwise, the modification module 1312m during a modification of the monitoring window. Either the monitoring module 1312d triggers the processing module 1312c which triggers the modification module supplying the resulting resolution Sr, or the monitoring module 1312d triggers the processing module 1312m which could then trigger the processing module 1312m, etc.

In particular, the display device 131 comprises a display module 1310 receiving the video stream fv and displaying the video carried by this video stream in the display window of the client depending on at least one video marker by read notably in a display database 1313. Thus, when the video marker stored in the database 1313 is the modified video marker written by the adaptor 1312, the display of the video is optimized in terms of size, of deformation and of quality.

In particular, the display device 131 comprises a module for managing the client window 1311. The display module 1310 and window management module 1311 exchange in such a manner that the video carried by the stream is displayed in the area of the window dedicated to the display of the video. Notably, the window management device 1311 reads and/or writes the size of the client window A and/or the size of the client menu M and/or the size of the menu of the service W from/in the database 1313.

In particular, a client 13 designed to display video streams fv comprises the adaptor 1312 for the display of the video stream. Notably, the client 13 comprises the display device 131 comprising the adaptor 1312.

In particular, the client 13 comprises a request module 130 receiving commands cmd from interaction of a user U with a terminal 1 and sending requests req to at least one video streaming device of 2, such as a video streaming server. The requests req are notably requests for connection to the video streaming device 2, and/or video stream catalogue requests and/or video streaming requests, etc. These requests are notably transmitted by means of the transmitter/receiver 10 of the terminal 1.

The requests req are notably requests for modification of the size of the client window A by the user U which are transmitted to the window management module 1311. In particular, the monitoring module 1312d of the adaptor 1312 exchanges and/or monitors the window management module 1311 of the display device.

In particular, a user U disposes of a terminal U for accessing videos offered by a remote server 2 also referred to as video streaming service provider device. The terminal 1 is a communications terminal comprising a transmitter/receiver 10 allowing the terminal 1 to exchange notably with the video streaming service provider device 2.

In particular, the terminal 1 comprises a display device, such as a screen, 11 and a user interface 12, such as the screen when it is a touchscreen or a keyboard, a mouse, a camera, a microphone, etc.

In particular, a client terminal 1 comprises:
a screen 11 designed to display, in a display window, a video stream fv supplied by a piece of equipment 2 executing an application and supplying a video stream displayed by the client terminal, distinct from the equipment
a user interface 12 allowing a positional interface to be moved over the screen 11 relative to an image of the video stream fv,
the device 132 for interaction with the equipment 2.

The user U interacts with the user interface 12 notably for controlling cmd the connection of the client device 13, notably integrated into the terminal 1, with the video streaming service provider device 2, then, potentially, the broadcast of a video stream.

The video carried by the video stream transmitted by the video streaming service provider device 2 will be displayed on the screen 2 for the user U in an optimal manner in terms of size, deformation and quality of display because the screen 2 is controlled by the display device 131 comprising an adaptor 1312 according to the invention.

The invention is also aimed at a medium. The information medium may be any given entity or device capable of storing the program. For example, the medium may comprise a storage means, such as a ROM, for example a CD ROM or a microelectronic circuit ROM or else a means of magnetic recording, for example a diskette or a hard disk.

On the other hand, the information medium may be a transmissible medium such as an electrical or optical signal which may be transported via an electrical or optical cable, by radio or by others means. The program according to the invention may in particular be downloaded over a network notably of the Internet type.

Alternatively, the information medium may be an integrated circuit into which the program is incorporated, the circuit being designed to execute or to be used in the execution of the method in question.

In another embodiment, the invention is implemented by means of software and/or hardware components. In this scenario, the term ‘module’ may just as well correspond to a software component as to a hardware component. A software component corresponds to one or more computer programs, one or more sub-programs of a program or, more generally, to any element of a program or of a software application designed to implement a function or a set of functions according to the description hereinabove. A hardware component corresponds to any element of a hardware assembly designed to implement a function or a set of functions.

1. A method for interaction with an application, executed by a piece of equipment, supplying a video stream displayed by a client terminal distinct from the equipment, the method of interaction comprising the transmission of appropriate position information as an interaction position input parameter for the application, the appropriate position information being dependent:
on a client position of a positional interface with respect to an image of the video stream,
and proportional to the ratio between a resolution of the equipment and an appropriate client resolution.

2. The method of interaction as claimed in claim 1, characterized in that the method comprises an adaptation of the client position of the positional interface in proportion to the ratio between the resolution of the equipment and the appropriate client resolution.

3. The method of interaction as claimed in claim 1, characterized in that the method of interaction comprises an acquisition of the appropriate client resolution, the appropriate client resolution being used by the client terminal as display video marker.

4. The method of interaction as claimed in claim 1, characterized in that the appropriate client resolution is a function of an equipment resolution, the equipment resolution being a resolution of a piece of equipment executing the application and supplying a resulting video stream, of a size of a display window of the video stream and of a precision parameter, the appropriate client resolution having the same relationship as the equipment resolution to the size of the display window in which the video stream is displayed by a terminal.

5. The method of interaction as claimed in claim 1, characterized in that each dimension of the appropriate position is equal to a corresponding dimension of the client position multiplied by the corresponding dimension of the equipment resolution multiplied by 1, from which the equipment resolution divided by the appropriate client resolution has been subtracted.

6. The method of interaction as claimed in claim 1, characterized in that the appropriate position information is a function of the position of a client display window relative to a screen of a client terminal displaying the client display window.

7. The method of interaction as claimed in claim 6, characterized in that each dimension of the appropriate position is shifted positively as a function of a corresponding dimension the position of the client display window multiplied by a corresponding dimension of the client position multiplied by the corresponding dimension of the equipment resolution divided by the appropriate client resolution.

8. The method of interaction as claimed in claim 1, characterized in that the image supplied by the execution of the application is supplied within a video stream broadcast in a real-time Web communication session.

9. The method of interaction as claimed in claim 1, characterized in that the method of interaction is implemented locally, when the application is executed remotely.

10. A program comprising program code instructions for the execution of steps of a method of interaction when said program is executed by a processor, the method for interaction with an application, executed by a piece of equipment, supplying a video stream displayed by a client terminal distinct from the equipment, the method of interaction comprising the transmission of appropriate position information as an interaction position input parameter for the application, the appropriate position information being dependent:
on a client position of a positional interface with respect to an image of the video stream,
and proportional to the ratio between a resolution of the equipment and an appropriate client resolution.

11. A device for interaction of a client terminal with a piece of equipment executing an application and supplying a video stream displayed by the client terminal distinct from the equipment, the interaction device comprising a transmitter, to the equipment, of appropriate position information as interaction position input parameter for the application, the appropriate position information being dependent:
on a client position of a positional interface with respect to an image of the video stream,
and proportional to the ratio between a resolution of the equipment and an appropriate client resolution.

12. A client terminal comprising:
a screen designed to display, in a display window, a video stream supplied by a piece of equipment executing an application, and supplying a video stream displayed by the client terminal distinct from the equipment,
a user interface allowing a positional interface to be moved over the screen relative to an image of the video stream,
a device for interaction of the client terminal with the equipment, comprising a transmitter, to the equipment, of appropriate position information as interaction position input parameter for the application, the appropriate position information being dependent:
on a client position of a positional interface with respect to an image of the video stream,
and proportional to the ratio between a resolution of the equipment and an appropriate client resolution.
